(19) United States
(12) Patent Application Publication
(10) Pub. No.: US 2018/0268739 A1
(43) Pub. Date: Sep. 20, 2018

(54) METHOD AND SYSTEM FOR GRADING FOREIGN LANGUAGE FLUENCY ON THE BASIS OF END-TO-END TECHNIQUE

(71) Applicant: Electronics and Telecommunications Research Institute, Daejeon (KR)

(72) Inventors: Hoon CHUNG, Daejeon (KR); Jeon Gue PARK, Daejeon (KR); Yoo Rhee OH, Daejeon (KR); Yun Kyung LEE, Daejeon (KR); Yun Keun LEE, Daejeon (KR)

(73) Assignee: Electronics and Telecommunications Research Institute, Daejeon (KR)

(21) Appl. No.: 15/709,686

(22) Filed: Sep. 20, 2017

(30) Foreign Application Priority Data
Mar. 20, 2017 (KR) 10-2017-0034849

(51) Int. Cl. G09B 19/06; G10L 15/22; G10L 15/02; G10L 15/16; G09B 5/00

(52) U.S. Cl. CPC G09B 19/06; G10L 15/22; G09B 5/00; G10L 15/16; G10L 15/02

(57) ABSTRACT

Provided are end-to-end method and system for grading foreign language fluency, in which a multi-step intermediate process of grading foreign language fluency in the related art is omitted. The method provides an end-to-end foreign language fluency grading method of grading a foreign language fluency of a non-native speaker from a non-native raw speech signal, and includes inputting the raw speech to a convolution neural network (CNN), training a filter coefficient of the CNN based on a fluency grading score calculated by a human rater for the raw signal so as to generate a foreign language fluency grading model, and grading foreign language fluency for a non-native speech signal newly input to the trained CNN by using the foreign language fluency grading model to output a grading result.

### CROSS-REFERENCE TO RELATED APPLICATIONS

This application claims priority under 35 U.S.C. § 119 to Korean Patent Application No. 10-2017-0034849, filed on 20 Mar. 2017, the disclosure of which is incorporated herein by reference in its entirety.

### TECHNICAL FIELD

The present invention relates to a technology of foreign language fluency or pronunciation evaluation which is applicable to a computer-based foreign language learning service. More particularly, this invention relates to a method and system for grading foreign language fluency on the basis of end-to-end technique which omits an intermediate process of grading fluency or pronunciation by using a convolution neural network.

### BACKGROUND

A conventional foreign language fluency evaluation system is largely configured with a grading model training unit and an automatic grading unit. The grading model training unit trains a grading model so as to increase a correlation between a result obtained by the automatic grading unit evaluating speech pronounced by a non-native speaker and a result obtained through grading performed by a grading expert(s). Such a process will be described below with reference to FIG. 1.

A raw non-native speech signal (hereinafter referred to as a ‘raw signal’) is collected in step 10. A feature vector suitable for speech recognition is extracted from the raw signal in step 11. Generally, mel-frequency cepstral coefficient (MFCC) and perceptual linear prediction (PLP) are used. Word and time sorting information about the extracted feature is obtained through automatic speech recognition, and a feature necessary for pronunciation evaluation is extracted based on the obtained word and time sorting information in step 13. In this case, the extracted feature varies according to the language characteristics. For example, features shown in FIG. 2 are widely used for evaluating or grading English fluency. An automatic grading system grades the extracted feature in steps 14 and 15. In order to increase the similarity between a result obtained through the automatic grading (15) and a result obtained through evaluation by the human evaluator (16), a regression or classification model is trained in step 17.

In a process of automatically grading speech pronounced by a non-native speaker by means of the trained grading model, steps 10 to 13 of the model training process described above with reference to FIG. 1 are performed, and then, a grade of an input feature is predicted by using the trained model.

In the related art foreign language fluency evaluation system, 1) a feature vector for speech recognition must be extracted from a raw signal, and 2) operational performance of speech recognition is not accurate. For this reason, 3) sophistication of a system for grading fluency using the above-described information is inevitably reduced, and 4) features for grading foreign language fluency are extracted through an objective and intuitive method. Also, 5) modules (for example, a speech recognition module, a feature extraction module, a grading model, etc.) used for fluency grading operate separately, and so, the related art foreign language fluency evaluation system has suboptimal performance that does not reach overall optimal performances.

### SUMMARY

Accordingly, it is an object of the present invention to provide a method and system for grading foreign language fluency on the basis of end-to-end technique, in which a multi-step intermediate process of grading foreign language fluency in the related art is omitted.

To accomplish the above object, the method and system for grading foreign language fluency on the basis of end-to-end technique according to the present invention proposes an end-to-end automatic grading which trains a convolution neural network (CNN) receiving directly a raw signal corresponding to the speech pronounced by a non-native speaker, so that it makes an output having a grade level comparable to that by a skilled grader.

In one general aspect, an end-to-end foreign language fluency grading method of grading a foreign language fluency of a non-native speaker from a non-native raw speech signal includes: inputting the raw speech to a convolution neural network (CNN); training a filter coefficient of the CNN based on a fluency grading score calculated by a human rater for the raw speech signal so as to generate a foreign language fluency grading model; and grading foreign language fluency for a non-native speech signal newly input to the trained CNN by using the foreign language fluency grading model to output a grading result.

In another general aspect, an end-to-end foreign language fluency grading system for grading a foreign language fluency of a non-native speaker from a non-native raw speech signal includes: a convolution neural network (CNN) for receiving the raw speech, training a filter coefficient of the CNN based on a fluency grading score calculated by a human rater for the raw speech signal so as to generate a foreign language fluency grading model, and grading foreign language fluency for a non-native speech signal newly input to the foreign language fluency grading model generated through the training to output a grading result.

When the above end-to-end foreign language fluency grading method trains the filter coefficient, it may use a number of [(non-native speech signal), (fluency grading score by the human rater)] pairs data.

The CNN may include a convolution multilayer. The convolution multilayer may include a first convolution layer which may perform a convolution operation based on local filtering on a non-native raw speech signal input thereto to provide a result of the convolution operation to an n-th (where n is a natural number equal to or more than two) convolution layer subsequent thereto.

The CNN may further include a plurality of fully connected layers for additionally training a result obtained from the convolution multilayer.

The grading of the foreign language fluency may be based on a silence section and an envelope included in the non-native speech signal newly input.

The convolution multilayer may include first to n-th convolution layers, and as n increases, a filter size is reduced.

In another general aspect, a convolution neural network (CNN) for grading foreign language fluency based on end-to-end includes: a first unit receiving a non-native raw speech signal and training a filter coefficient of the CNN based on a fluency grading score calculated by a human rater for the raw speech signal so as to generate a foreign language fluency grading model; and a second unit grading foreign language fluency for a non-native speech signal newly input to the generated foreign language fluency grading model to output a grading result.

A number of [(non-native speech signal), (fluency grading score by the human rater)] pairs data may be used for training the foreign language fluency grading model.

The second unit may include a convolution multilayer. The convolution multilayer may include a first convolution layer, which may perform a convolution operation based on local filtering on a non-native raw speech signal input thereto to provide a result of the convolution operation to an n-th (where n is a natural number equal to or more than two) convolution layer subsequent thereto.

The convolution multilayer may include a first to n-th convolution layers, and as n increases, a filter size is reduced.

The second unit may further include a plurality of fully connected layers for additionally training a result obtained from the convolution multilayer.

The second unit may be based on a silence section and an envelope included in the non-native speech signal.

Other features and aspects will be apparent from the following detailed description, the drawings, and the claims.

### BRIEF DESCRIPTION OF THE DRAWINGS

FIG. 1 is a flowchart illustrating a grading model training process of a related art foreign language fluency evaluation system.

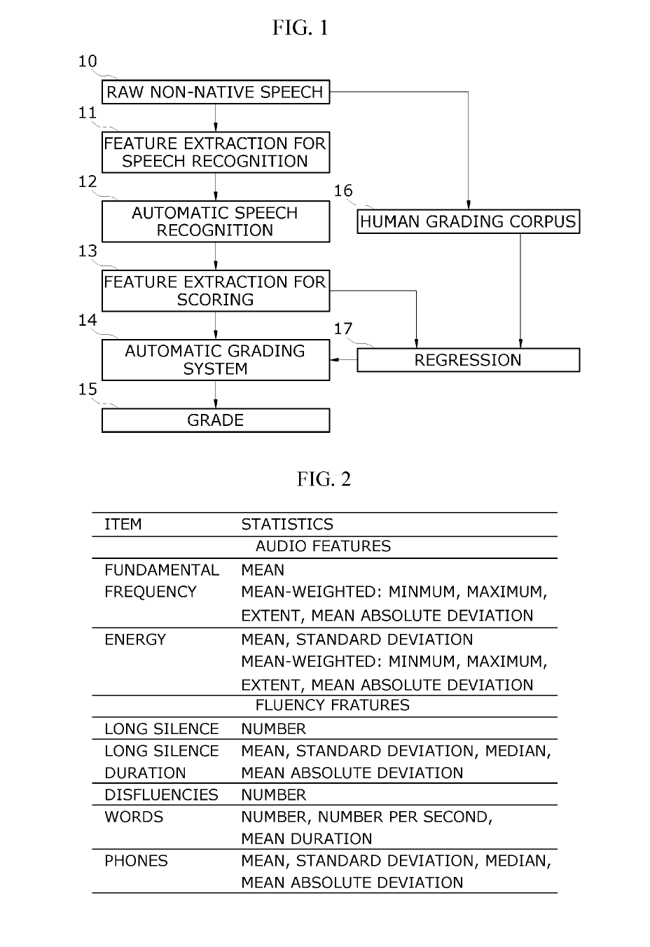

FIG. 2 is a diagram showing feature data for grading English fluency in the related art.

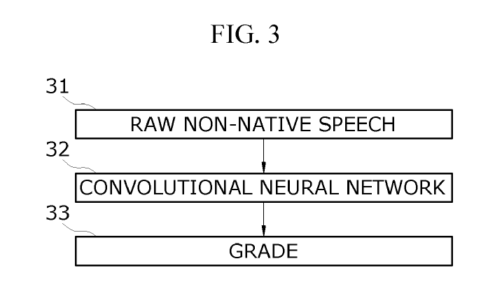

FIG. 3 is a flowchart for describing a conceptual of generating a convolution neural network (CNN)-based foreign language fluency grading model according to an embodiment of the present invention.

FIG. 4 is a block diagram illustrating a fundamental configuration of a CNN according to an embodiment of the present invention.

FIG. 5 is a block diagram of a CNN-based fluency grading system according to an embodiment of the present invention.

FIG. 6 is an exemplary diagram showing parameter values by blocks of FIG. 5.

FIG. 7 is a diagram illustrating a model having a CNN structure.

FIG. 8A-C is a waveform diagram of speeches pronounced by different speakers for a sentence “The cats should have eaten the hotdog.”

FIGS. 9A-C to 11A-C are a filter output waveform diagram of each convolution layer, wherein FIG. 9A-C is for a conv-1 layer, FIG. 10A-C is for a conv-2 layer, and FIG. 11A-C is for a conv-3 layer.

### DETAILED DESCRIPTION OF EMBODIMENTS

In order to solve a problem of conventional foreign language fluency grading technology, the present invention proposes an end-to-end foreign language fluency grading system which inputs a raw signal, corresponding to speech pronounced by a non-native speaker, to a convolution neural network (CNN), trains a grading model at a level corresponding to a score (a grade) graded by a human rater or grader to build a foreign language fluency grading model, and grades foreign language fluency by using the built model, thereby directly and automatically outputting an optical grading score without performing a related art feature vector extraction process.

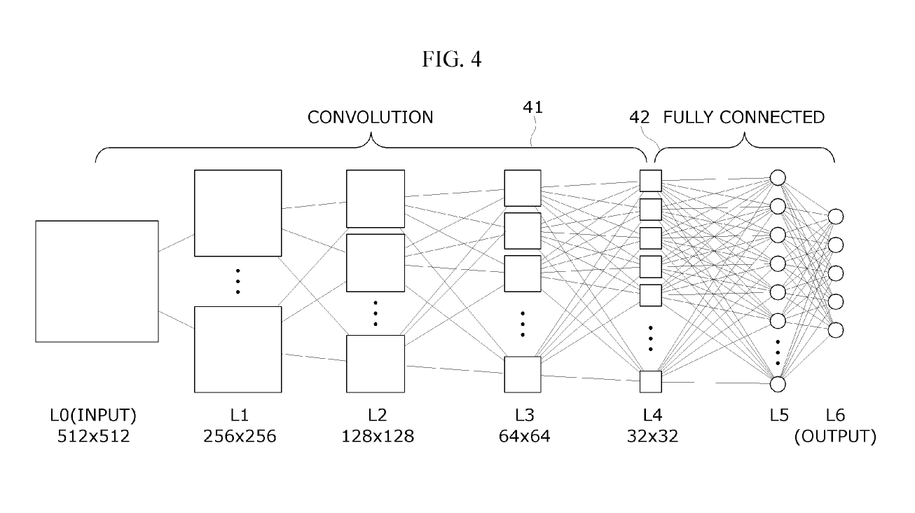

A concept of the present invention uses a CNN as in FIG. 3. CNN is very useful for classification in that the number of calculations is reduced based on a shared parameter, overfitting is reduced, and useful features are generated. As in FIG. 3, a raw non-native speech 31 is input to a CNN 32 which is trained until having a level equal to a grade graded by a human rater so as to generate a foreign language fluency grading model. The grade 33 is output by using the generated foreign language fluency grading model.

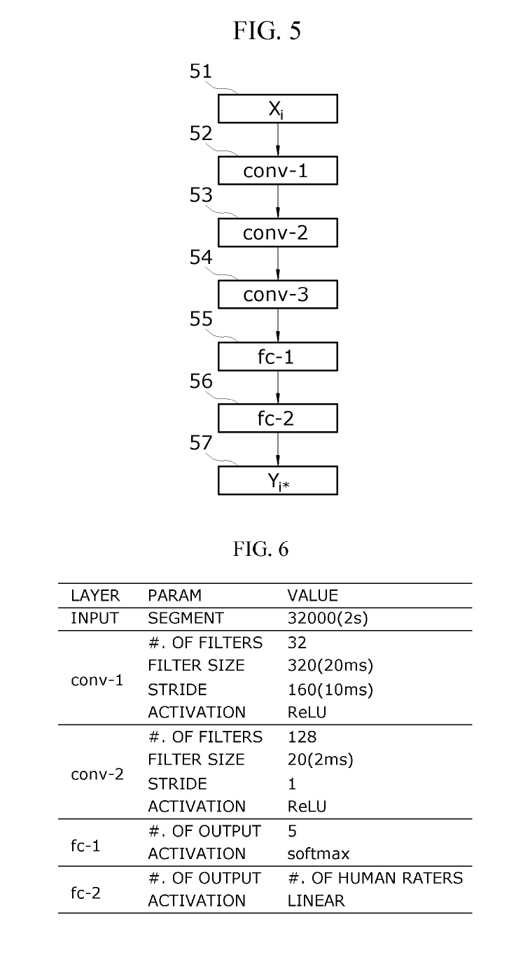

The CNN predicts a fluency grading score of an input speech signal through a training process. In order to train the CNN, a number of [(speech signal), (fluency grading score by a human rater)] pairs are needed. Here, the fluency grading score made by the human rater is pronunciation score data which is provided as a result obtained by human rater's actually listening to and grading the speech. That is to say, the training of the CNN means a process of training a filter coefficient to obtain a conventional fluency grading score made by a human rater corresponding to an input signal. FIG. 4 illustrates a CNN in which a raw speech pronounced by a non-native speaker is directly used as an input L0, and it includes a convolution multilayer (including a plurality of convolution layers L1 to L4) 41 and a fully connected multilayer (including a plurality of fully connected layers F5 and F6) 42. The convolution multilayer performs local filtering on a signal input thereto and transfers a signal, obtained through the local filtering, to a next layer. A filter coefficient of the convolution multilayer is trained through a forward-path process and a backward-path process. In the forward path process, a local filtered value is calculated by sliding a filter. In the backward path process, a filter coefficient is trained by backward propagating a difference between the local filtered value and a target value (this is called an “error backward propagation technique”). In this manner, when the CNN has been trained, a pronunciation score equal to a score obtained when a human rater grades an input signal may be obtained for a new input signal.

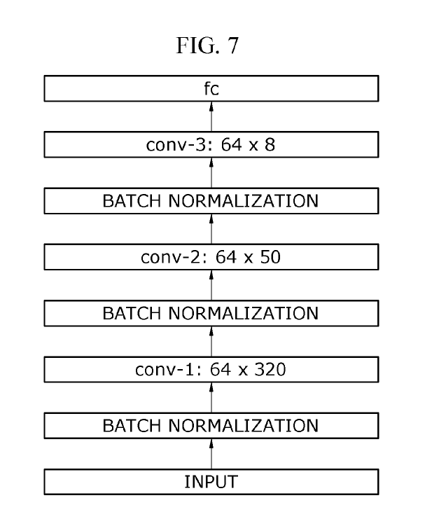

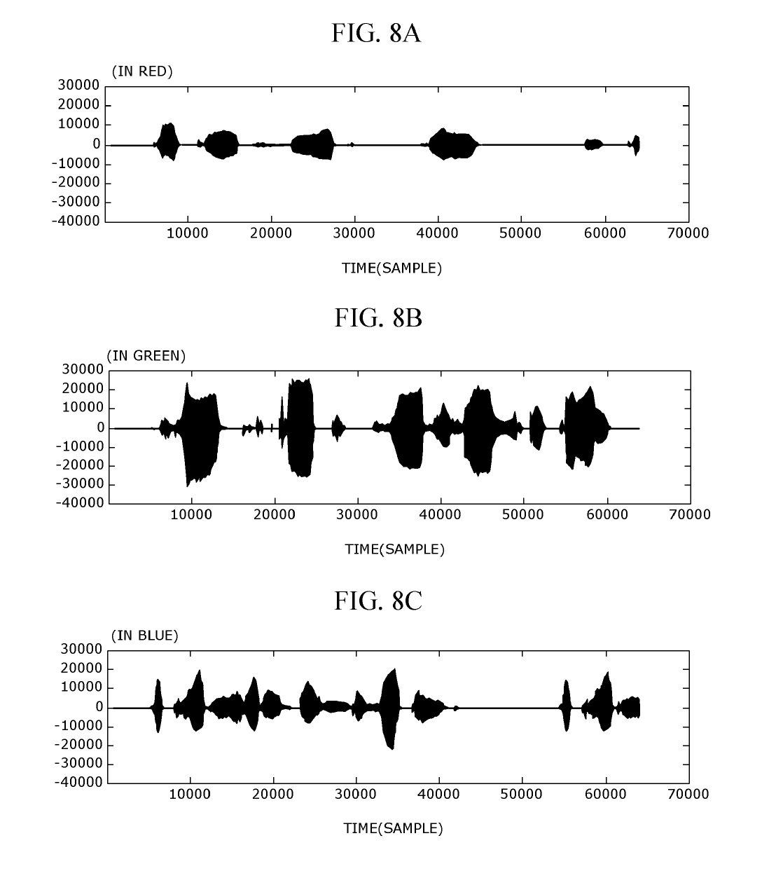

FIG. 5 is a block diagram according to an embodiment of the present invention, which shows a configuration and a training process of a CNN-based fluency grading system. Also, FIG. 6 exemplarily shows parameter values in each step of FIG. 5.

First, an input “xᵢ” 51 denotes a raw time-domain signal, the segment parameter of which is 32,000 samples corresponding to 2 seconds. “yᵢ” 57 denotes a fluency grading score obtained to the input “xᵢ” 51 by a grading expert. “Conv-1” 52 is a first convolution layer and is configured with 32 filters. Each of the filters outputs a convolution result for 320 input samples and slides in units of 160 samples. “Conv-2” 53 is a second convolution layer and performs a convolution operation on an output of the conv-1 52 by using the 32 filters to output a result of the convolution. In this case, a filter size, that is a convolution size, corresponds to 50 samples, and sliding is performed in units of 10 samples. “Conv-3” 54 is a third convolution layer and performs a convolution operation on a result obtained by the conv-2. In this case, a filter size corresponds to 20 samples, and sliding is performed in units of one sample.

“fc-1” 55 and “fc-2” 56 are each a fully connected layer. An activation function for the fully connected layer 55 is ‘softmax’ and an activation function for the fully connected layer 55 is ‘linear’. An output of a fully connected layer is configured with a grade performed by a human rater. When features obtained through a convolution layer are additionally trained through a fully connected layer, stronger signal characteristics can be realized and thus topology-change-robust recognition ability can be obtained.

Therefore, a CNN where a grade obtained by human rater's grading a raw signal generated by a non-native speaker is used as an output value is trained. As described above, coefficients constituting the CNN are trained through the forward-path process and the backward-path process. In the forward path, a fluency grading score predicted by the CNN for an input speech signal is output; in the backward path, a filter coefficient is trained by backward propagating a difference between the predicted fluency grading score and a grading score graded by the human rater.

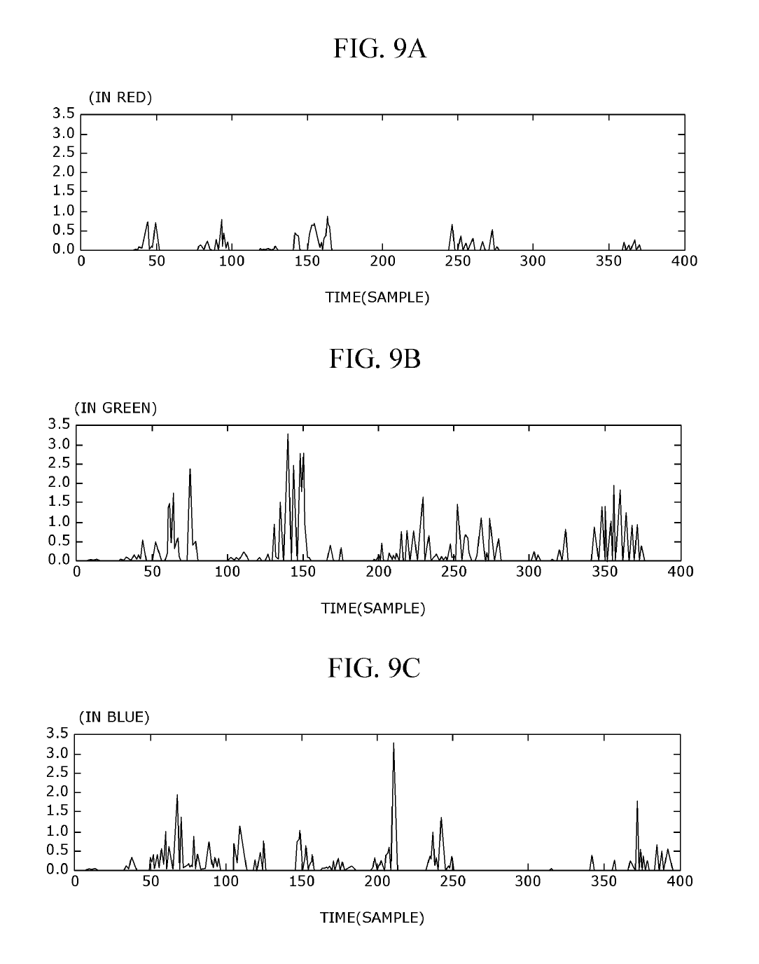

To this end, in an embodiment of the present invention, a model having a CNN structure illustrated in FIG. 7 is used. A batch normalization layer (BN) is stacked, for normalizing, according to a target function, a mean and a variance of input time-domain signals provided in units of 320 samples. Subsequently, a CNN layer “conv-1” having 64 filters is stacked. BN is again stacked for normalizing an output of the conv-1, and a CNN layer “conv-2” having 64 filters is stacked again. In this case, a filter coefficient of the conv-2 layer is used as a 50 order. An output of the conv-2 is again normalized by the BN layer, and a conv-3 layer is stacked. The conv-3 layer also has 64 filters, but in this case, a filter coefficient is used as 8. Finally, by stacking a fully connected multilayer fc, a probability value of a score which is to be predicted is calculated.

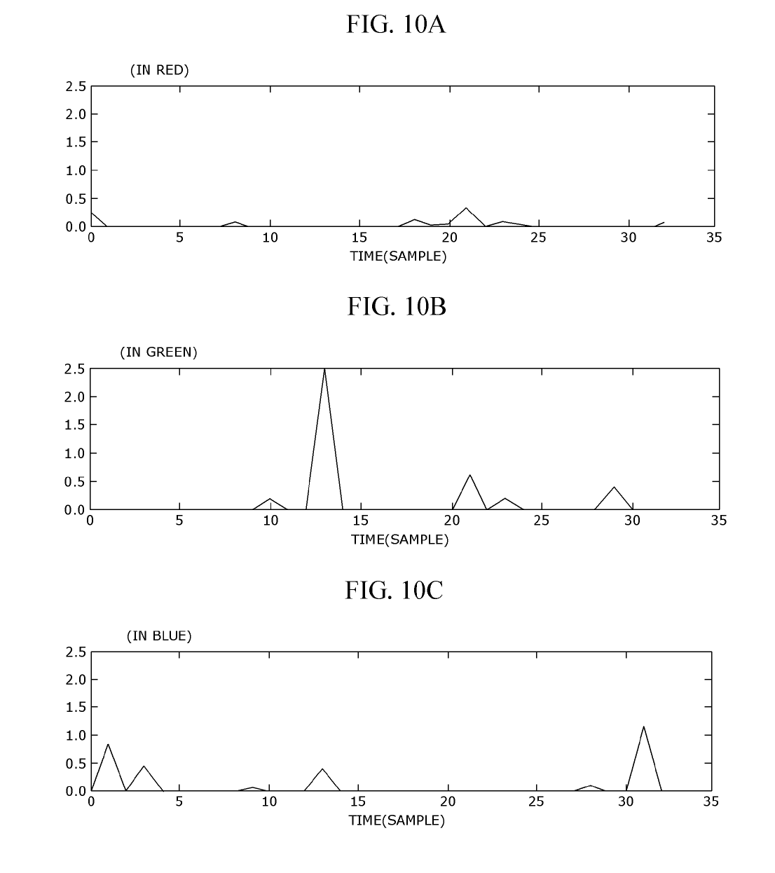

FIGS. 8A-C and 9A-C to 11A-C show speech waveforms actually measured in experiment of the embodiment of the present invention illustrated in FIG. 5.

As described above, training in the end-to-end fluency grading according to an embodiment of the present invention is automatically finding which filter is proper for an accuracy of a fluency grading result. The followings explain that the filter of a CNN found through the end-to-end training is relevant for fluency grading.

FIGS. 8A to 8C are waveform diagrams of speeches pronounced by different speakers for a sentence “The cats should have eaten the hotdog”. Although colors are not depicted on the waveforms, it is desirable that actual waveforms showing fluency scores of pronunciations are to be expressed in different colors. Concretely, a FIG. 8A waveform (may be in red color) indicates a score of one, a FIG. 8B waveform (may be in green color) is a score of two, and a FIG. 8C waveform (may be in blue color) indicates a score of five. (5 is a full score. The higher a score is, the better the pronunciation fluency is.)

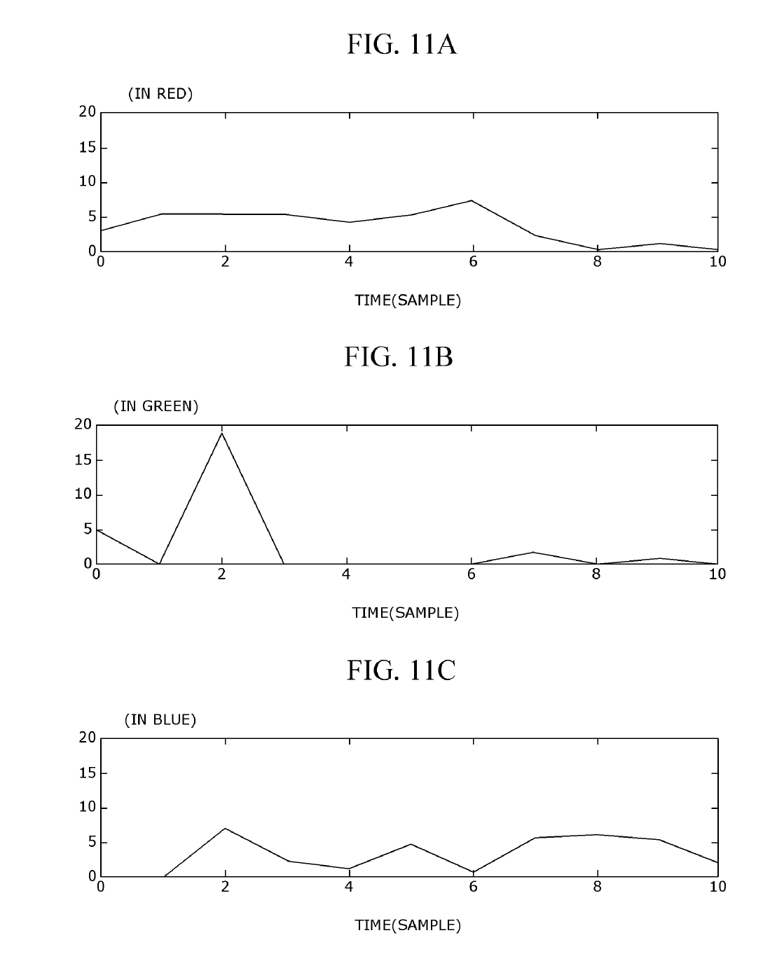

FIGS. 9A to 9C show a filter output of the conv-1 layer having a higher activation frequency for different input signals. It is likely that a filter has been automatically trained to output a level of an input signal as shown. This is a significant result because the most important items in grading foreign language fluency are a speech envelope and a silence section.

FIGS. 10A-C and 11A-C respectively show an output waveform of the conv-2 and an output waveform of the conv-3. In comparison with an output of the conv-1, it is difficult to intuitively construe an output of the conv-1 and an output of the conv-1. Considering a general perspective, however, it may be construed that a result thereof is output to emphasize the magnitude of a speech and a part which helps grade the fluency in a silence section.

As described above, according to the embodiments of the present invention, a related art step-based foreign language grading processes which are complicated and independent may be performed as one integration process by using the CNN, thereby solving the problems of the related art and considerably improving a grading performance.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An end-to-end foreign language fluency grading method of grading a foreign language fluency of a non-native speaker from a non-native raw speech signal (hereinafter, “raw signal”), the method comprising:
inputting the raw signal to a convolution neural network (CNN) and training a filter coefficient of the CNN based on a fluency grading score calculated by a human rater for the raw signal so as to generate a foreign language fluency grading model; and
grading foreign language fluency for a non-native speech signal newly input to the trained CNN by using the foreign language fluency grading model to output a grading result.

2. The end-to-end foreign language fluency grading method of claim 1, wherein the training of the filter coefficient uses a number of [(non-native speech signal), (fluency grading score by a human rater)] pairs data.

3. The end-to-end foreign language fluency grading method of claim 1, wherein the CNN comprises a convolution multilayer; and wherein the convolution multilayer comprises a first convolution layer, the first convolution layer performing a convolution operation based on local filtering on the raw signal input thereto to provide a result of the convolution to an n-th (where n is a natural number equal to or more than two) convolution layer subsequent thereto.

4. The end-to-end foreign language fluency grading method of claim 3, wherein the CNN further comprises a plurality of fully connected layers for additionally training a result obtained from the convolution multilayer.

5. The end-to-end foreign language fluency grading method of claim 1, wherein the grading of the foreign language fluency is based on a silence section and an envelope included in the non-native speech signal.

6. The end-to-end foreign language fluency grading method of claim 1, wherein the convolution multilayer comprises first to n-th convolution layers, and as n increases, a filter size is reduced.

7. An end-to-end foreign language fluency grading system for grading a foreign language fluency of a non-native speaker from a non-native raw speech signal (hereinafter, “raw signal”), the system comprising:
a convolution neural network (CNN) for receiving the raw signal; training a filter coefficient of the CNN based on a fluency grading score calculated by a human rater for the raw signal so as to generate a foreign language fluency grading model; and grading foreign language fluency for a non-native speech signal newly input to the foreign language fluency grading model generated through the training to output a grading result.

8. The end-to-end foreign language fluency grading method of claim 7, wherein a number of [(non-native speech signal), (fluency grading score by the human rater)] pairs data are used for training the filter coefficient of the CNN.

9. The end-to-end foreign language fluency grading system of claim 7, wherein the CNN comprises a convolution multilayer; and wherein the convolution multilayer comprises a first convolution layer, the first convolution layer performing a convolution operation based on local filtering on the raw signal input thereto to provide a result of the convolution operation to an n-th (where n is a natural number equal to or more than two) convolution layer subsequent thereto.

10. The end-to-end foreign language fluency grading system of claim 9, wherein the CNN further comprises a plurality of fully connected layers for additionally training a result obtained from the convolution multilayer.

11. The end-to-end foreign language fluency grading system of claim 7, wherein the generating the foreign language fluency grading model is based on a silence section and an envelope included in the non-native speech signal.

12. The end-to-end foreign language fluency grading system of claim 7, wherein the convolution multilayer comprises first to n-th convolution layers, and as n increases, a filter size is reduced.

13. A convolution neural network (CNN) for grading a foreign language fluency of a non-native speaker from a non-native raw speech signal (hereinafter, “raw signal”), the CNN comprising:
a first unit receiving the raw signal and training a filter coefficient of the CNN based on a fluency grading score calculated by a human rater for the raw signal so as to generate a foreign language fluency grading model; and
a second unit grading foreign language fluency for a non-native speech signal newly input to the generated foreign language fluency grading model to output a grading result.

14. The CNN of claim 13, wherein a number of [(non-native speech signal), (fluency grading score by the human rater)] pairs data are used for training the foreign language fluency grading model.

15. The CNN of claim 13, wherein the second unit comprises a convolution multilayer; and wherein the convolution multilayer comprises a first convolution layer, the first convolution layer performing a convolution operation based on local filtering on the raw signal input thereto to provide a result of the convolution operation to an n-th (where n is a natural number equal to or more than two) convolution layer subsequent thereto.

16. The CNN of claim 15, wherein the second unit further comprises a plurality of fully connected layers for additionally training a result obtained from the convolution multilayer.

17. The CNN of claim 13, wherein the second unit is based on a silence section and an envelope included in the non-native speech signal.

18. The CNN of claim 13, wherein the convolution multilayer comprises first to n-th convolution layers, and as n increases, a filter size is reduced.
